(19) United States
(12) Patent Application Publication
(10) Pub. No.: US 2006/0041584 A1
(43) Pub. Date: Feb. 23, 2006

(54) System and method for communicating with a structured query language statement generator

(76) Inventors: Dirk Debertin, Karisruhe (DE); Viktoriya Ivanova, Sofia (BG); Rainer Schweigkoffer, Mannheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/863,127

(22) Filed: Jun. 7, 2004

(51) Int. Cl. G06F 17/00

(52) U.S. Cl. 707/103 R

(57) ABSTRACT

A system and method are provided for communicating with a Structured Query Language (SQL) statement generator. In an embodiment, an SQL mapper factory receives an object-relational mapping schema to define a mapping between one or more persistence fields of one or more Enterprise Java Beans (EJBs) and one or more tables of a database. An SQL mapper implementation may be selected based, at least in part, on a value specified in a properties file. In an embodiment, the SQL mapper implementation may be generated based, at least in part, on the object-relational mapping schema.

### TECHNICAL FIELD

Embodiments of the invention generally relate to the field of data processing and, more particularly, to a system and method for communicating with a Structured Query Language (SQL) generator.

### BACKGROUND

Many businesses are providing access to their products and services through applications that are delivered over computer networks such as the Internet. These applications typically have a multi-tiered architecture. In those cases where the applications are delivered over the Internet they are commonly referred to as Web-based applications. FIG. 1 is a block diagram of a Web-based application 100 having a multi-tiered architecture.

Web-based application 100 includes client layer 110, application layer 120, and database layer 130. Client layer 110 includes user interface 112 that runs on a client computing device such as a desktop computer, laptop computer, personal digital assistant, telephone, and the like. In a Web-based environment, user interface 112 is typically a Web browser. User interface 112 may collect input from a user and provide that input to application layer 120 for processing.

Application layer 120 includes application server 122 to receive and process input from client layer 110. Application server 122 typically includes a number of subcomponents including, for example, connectivity layer 140, presentation logic 142, business logic 144, and database interface 146. Connectivity layer 140 provides connections to client layer 110 using protocols such as the HyperText Transfer Protocol (HTTP), HTTP secured through the Secure Socket Layer, the Simple Object Access Protocol (SOAP), and the like. Presentation logic 142 generates a Graphical User Interface (GUI) using, for example, a markup language such as the Hyper Text Markup Language (HTML). Business logic 144 represents the core of the application, for example, the rules governing the underlying business process (or other functionality) provided by the application. Database interface layer 146 provides an interface to database layer 130. The Java 2 Enterprise Edition Specification v1.3, published on Jul. 27, 2001 (the J2EE Standard) defines an increasingly popular architecture for application layer 120.

Database layer 130 includes data access logic used by business logic 144 to store and retrieve data in database 132. Database 132 provides non-volatile storage (sometimes referred to as a persistent store) for the data accessed and/or processed by application layer 120. Database 132 may be, for example, a relational database or an object-oriented database.

In some cases, business logic 144 may be implemented with Enterprise Java Beans (EJBs). EJBs are server-side J2EE components that provide business logic and represent persistent data. Although EJBs provide a flexible architecture for business logic 144, they also introduce a certain amount of complexity.

FIG. 2 is a block diagram of distributed system 200 illustrating some of the complexity of implementing business logic 210 with EJBs 211-216. EJBs 211-216 are developed from an objected-oriented point-of-view. That is, objects are typically accessed by identifying a first object as a starting point and finding additional objects by, for example, following references or calling methods. In contrast, database 220 is typically organized according to a completely different organizational model that is based on set-oriented query and update statements.

Conventional mapping architecture 230 attempts to map the object-oriented domain of business logic 210 to the relational domain of database 220. Conventional mapping architecture 230 is typically only able to process a limited set of the queries that are generated by business logic 210. In addition, conventional mapping architecture 230 is typically constrained to interoperating with a database provided by a particular vendor.

### SUMMARY OF THE INVENTION

A system and method are provided for communicating with a Structured Query Language (SQL) statement generator. In an embodiment, an SQL mapper factory receives an object-relational mapping schema to define a mapping between one or more persistence fields of one or more Enterprise Java Beans (EJBs) and one or more tables of a database. An SQL mapper implementation may be selected based, at least in part, on a value specified in a properties file. In an embodiment, the SQL mapper implementation may be generated based, at least in part, on the object-relational mapping schema.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a Web-based application having a multi-tiered architecture.

FIG. 2 is a block diagram of a distributed system that illustrates some of the complexity of implementing business logic with Enterprise Java Beans (EJBs).

FIG. 3 is a block diagram illustrating a distributed system implemented according to an embodiment of the invention.

FIG. 4 is a block diagram of selected aspects of a mapping architecture, implemented according to an embodiment of the invention.

FIG. 5 is a block diagram of selected aspects of an SQL mapper implementation, implemented according to an embodiment of the invention.

FIGS. 6a-6b are a conceptual illustration of generating an SQL statement, according to an embodiment of the invention.

FIG. 7 is a block diagram of selected aspects of a communication protocol (and application program interface) between an EJB container and an SQL statement generator.

FIG. 8 is a flow diagram illustrating selected aspects of a communication process according to an embodiment of the invention.

FIG. 9 is an illustration of selected elements of an object-relational mapping schema according to an embodiment of the invention.

FIG. 10 is a flow diagram illustrating selected aspects of a communication process according to an embodiment of the invention.

FIG. 11 is a block diagram of a node implemented according to an embodiment of the invention.

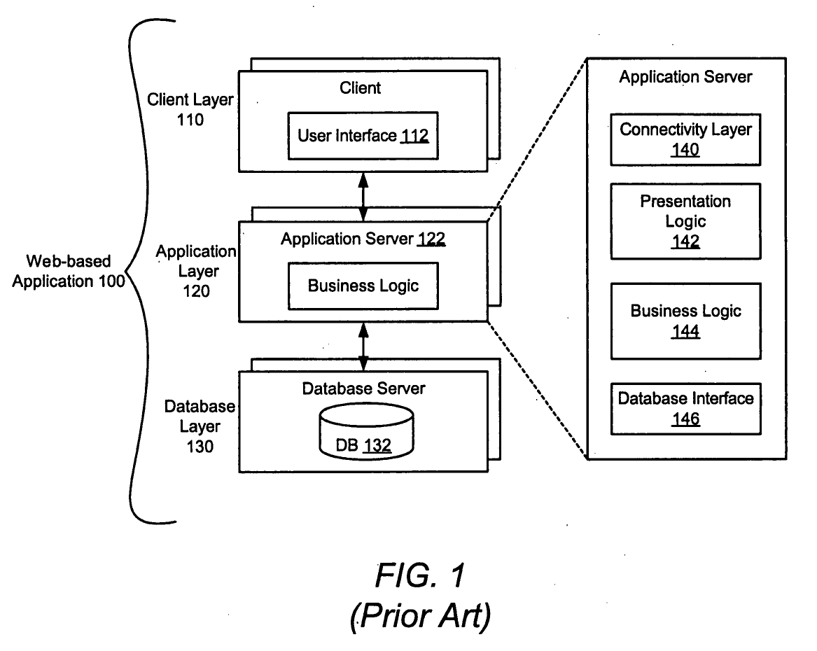

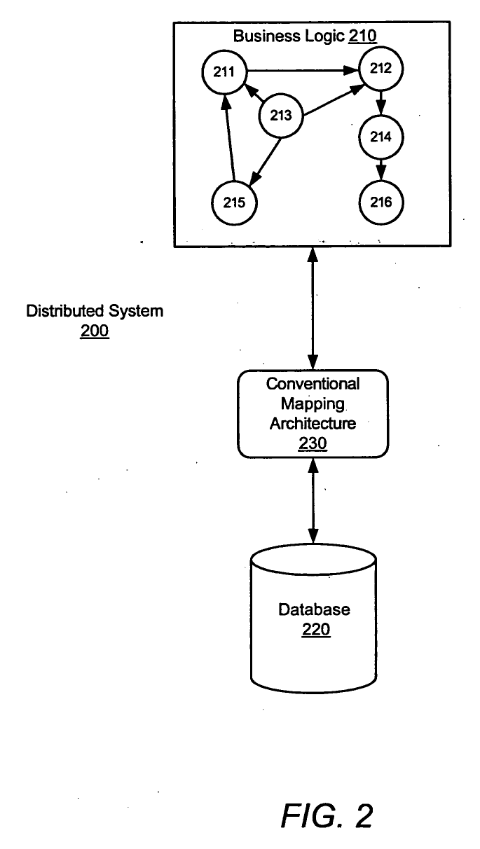

### DETAILED DESCRIPTION

A system and method are provided for communicating with a Structured Query Language (SQL) statement generator. In an embodiment, an SQL mapper factory receives an object-relational mapping schema to define a mapping between one or more persistence fields of one or more Enterprise Java Beans (EJBs) and one or tables of a database. An SQL mapper implementation may be selected based, at least in part, on a value specified in a properties file. In an embodiment, the SQL mapper implementation may be generated based, at least in part, on the object-relational mapping schema.

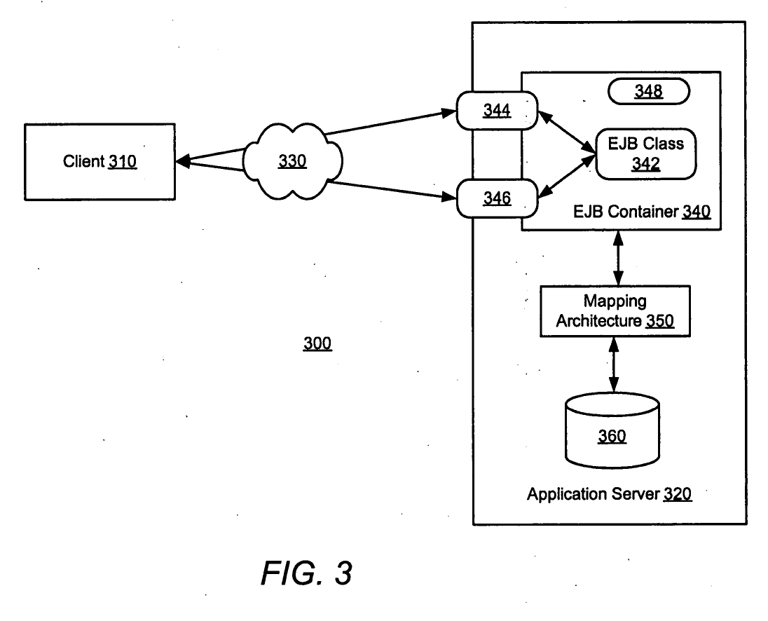

FIG. 3 is a block diagram illustrating distributed system 300 implemented according to an embodiment of the invention. Distributed system 300 includes client 310 and application server 320. Client 310 may collect input from a user and provide that input to application server 320 via network 330 for processing. Client 310 may be, for example, a desktop computer, a laptop computer, a personal digital assistant, a telephone, an application server, and the like. Network 330 may be, for example, any combination of a wired or wireless Local Area Network (LAN), Wide Area Network (WAN), Metropolitan Area Network (MAN), intranet, and/or the Internet.

Application server 320 receives information from client 310 and may generate a response after processing the information. In an embodiment, application server 320 is based, at least in part, on the J2EE standard (e.g., IBM's Websphere platform). In an alternative embodiment, application server 320 may be based on a different platform such as Microsoft Corporation's .Net platform. The illustrated embodiment of application server 320 includes EJB container 340, mapping architecture 350, and database 360. In an alternative embodiment, application server 320 may include more elements, fewer elements, and/or different elements.

EJB container 340 is the environment in which EJBs reside. EJB container 340 enables multiple EJBs to be deployed to application server 320 and makes them accessible through a naming service such as the Java Naming and Directory Interface (JNDI). EJB container 340 provides deployed beans with services such as persistence, transaction handling, pooling, security, exception handling, and the like. At runtime, EJB container 340 creates instances of the bean class (e.g., bean class instance 342) and manages the lifecycle of the instances of the bean class.

An EJB typically has four basic elements: instance of the bean class 342, object interface 344, home interface 346, and deployment descriptor 348. Bean class 342 implements business methods that may be declared in, for example, object interface 344. Home interface 346 may define one or more methods used by client 310 to find and/or remove bean class 342. Deployment descriptor 348 may be an eXtensible Markup Language (XML) file containing metadata that, for example, describes an EJB's structure and its relationships to other EJBs. An entity EJB is an EJB that represents specific data or collections of data such as a row in a relational database (e.g., database 360).

In an embodiment, mapping architecture 350 receives persistency requests from EJB container 340 and generates Structured Query Language (SQL) statements based, at least in part, on the received persistency requests. EJB container 340 may use the generated SQL statements to, for example, implement Container Managed Persistence (CMP).

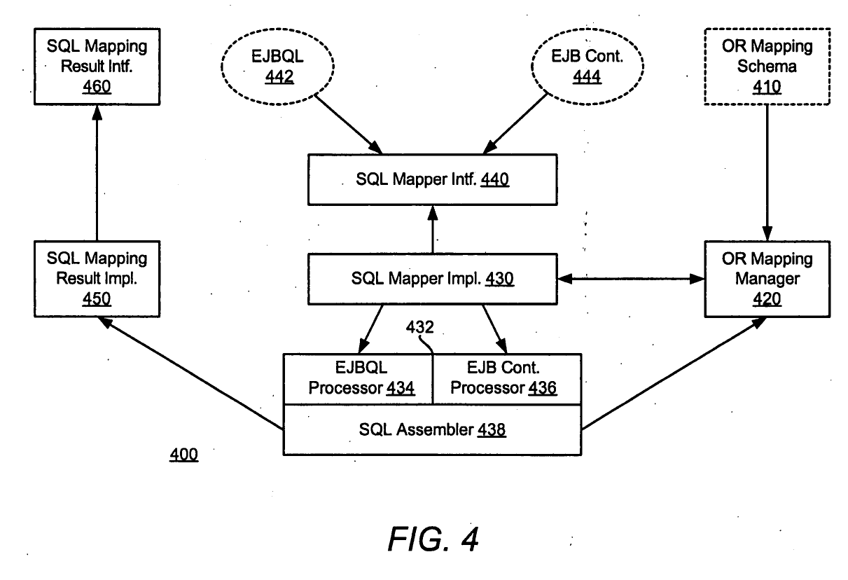

In an embodiment, the persistency requests received by mapping architecture 350 may be grouped into two categories: user-defined EJB Query Language (EJBQL) persistency requests and EJB container persistency requests. In an embodiment, user-defined EJBQL persistency requests may be based, at least in part, on ejbSelect( ) methods and ejbFinder( ) methods. Similarly, in an embodiment, EJB container persistency requests may be based, at least in part, on ejbLoad( ) methods, ejbStore( ) methods, and/or ejbRemove( ) methods as well as methods for manipulating and maintaining Container Managed Relationships (CMRs). Mapping architecture 350 is further described below with reference to FIGS. 4-7.

FIG. 4 is a block diagram of selected aspects of mapping architecture 400, implemented according to an embodiment of the invention. In an embodiment, mapping architecture 400 receives persistence requests from an EJB container (e.g., EJB container 340, shown in FIG. 3), generates SQL statements based, at least in part, on the persistence requests, and provides the SQL statements to the EJB container (e.g., via SQL mapping result interface 460).

In an embodiment, mapping architecture 400 is assigned an Object/Relational (OR) mapping schema 410 to determine the mapping between, for example, entity EJBs, database tables (e.g., the tables of database 360, shown in FIG. 3), and Container Managed Relations (CMRs). In an embodiment, mapping architecture 400 wraps OR mapping schema 410 into OR mapping manager 420. Mapping manager 420 may transform the data provided by OR mapping schema 410 into the form used by the classes of mapping architecture 400. In addition, mapping manager 420 may cache a derived form of the data (or a portion of the data) to increase the performance of mapping architecture 400. In one embodiment, the methods of various elements of mapping architecture 400 (e.g., the methods of OR mapping manager 420) are thread safe.

In an embodiment a catalog reader may validate the data in OR mapping schema 410 against an underlying database (e.g., database 360, shown in FIG. 3). In such an embodiment, OR mapping manager 420 may provide a catalog interface. The catalog interface may be implemented with a number of classes including, for example, an ORMapCatalogReader class, an ORMapColumnIterator class, a TableDescriptor class, and/or a ColumnDescriptor class.

In an embodiment, SQL mapper implementation 430 provides a number of interfaces and classes to implement the core functionality of mapping architecture 400. For example, in an embodiment, SQL mapper implementation 430 provides SQL mapper interface 440 to receive persistence requests from an EJB container (e.g., EJB container 340, shown in FIG. 3). In one embodiment, the received requests may include EJBQL persistence requests 442 and/or EJB container persistence requests 444. In an embodiment, SQL mapper interface 440 passes the received persistence requests to SQL mapper implementation 430 for processing.

In an embodiment, SQL mapper implementation 430 employs a two-layer set of classes to process persistence requests that it receives from SQL mapper interface 440. For example, the illustrated embodiment of SQL mapper implementation 430 includes EJB interpreting layer 432 and SQL assembly layer 438. In one embodiment, the purpose of EJB interpreting layer 432 is to interpret received EJB persistence requests and to send a sequence of commands (e.g., method calls) to the SQL assembly layer 438. In an embodiment, the purpose of SQL assembly layer 438 is to assemble SQL statements based, at least in part, on the sequence of commands received from EJB interpreting layer 432.

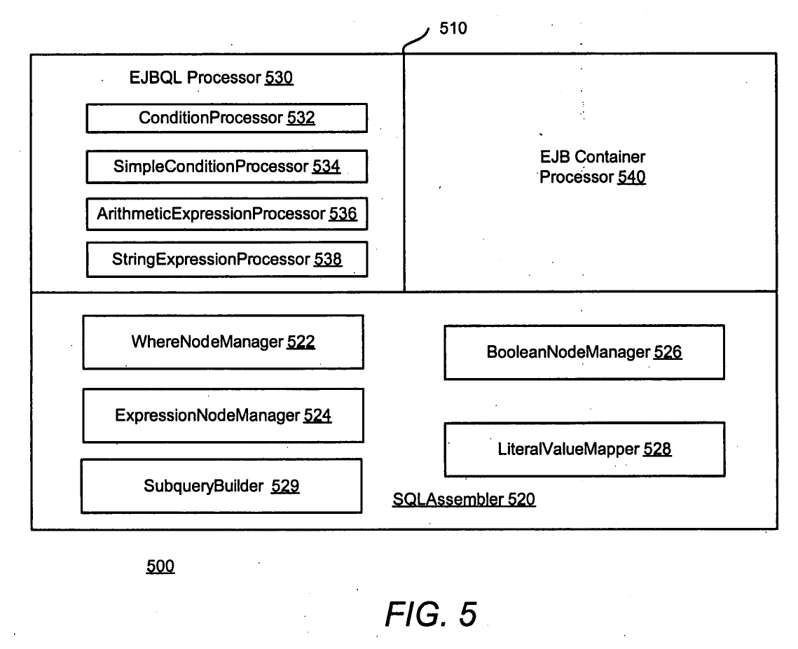

In an embodiment, EJB interpreting layer 432 is divided into two sections: EJBQL persistence request processor 434 (or, for ease of discussion, EJBQL processor 434) and EJB container persistence request processor 436 (or, for ease of discussion, EJB container processor 436). In such an embodiment, the purpose of EJBQL processor 434 is to interpret EJBQL persistence requests and to send a sequence of commands to SQL assembly layer 438 based, at least in part, on the persistence requests. Similarly, the purpose of EJB container processor 436 may be to interpret EJB container persistence requests and send a sequence of commands to SQL assembly layer 438 based, at least in part, on the persistence requests. SQL mapper implementation 430 is further discussed below with reference to FIGS. 5-7.

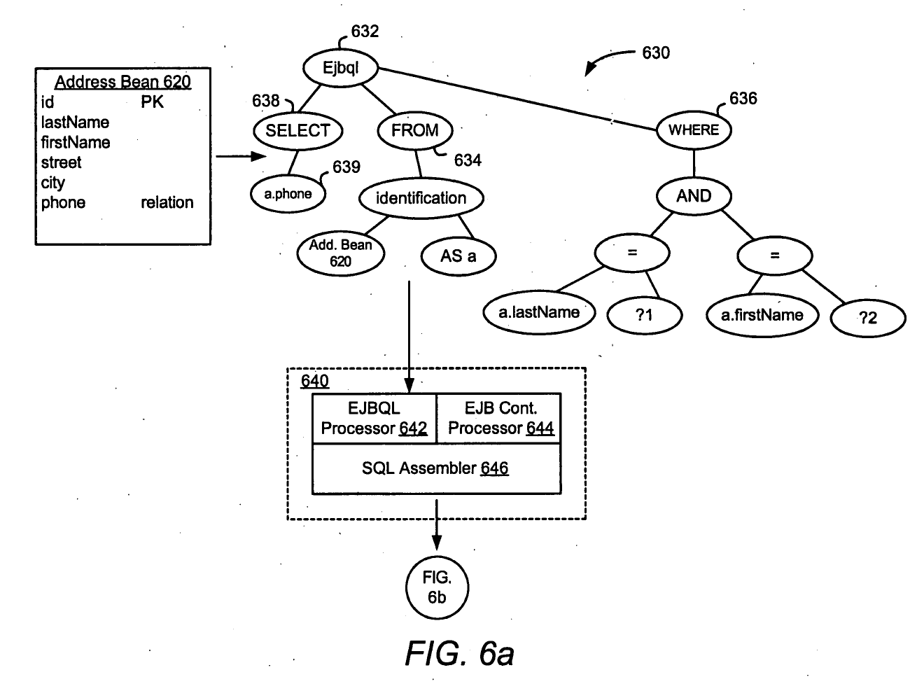

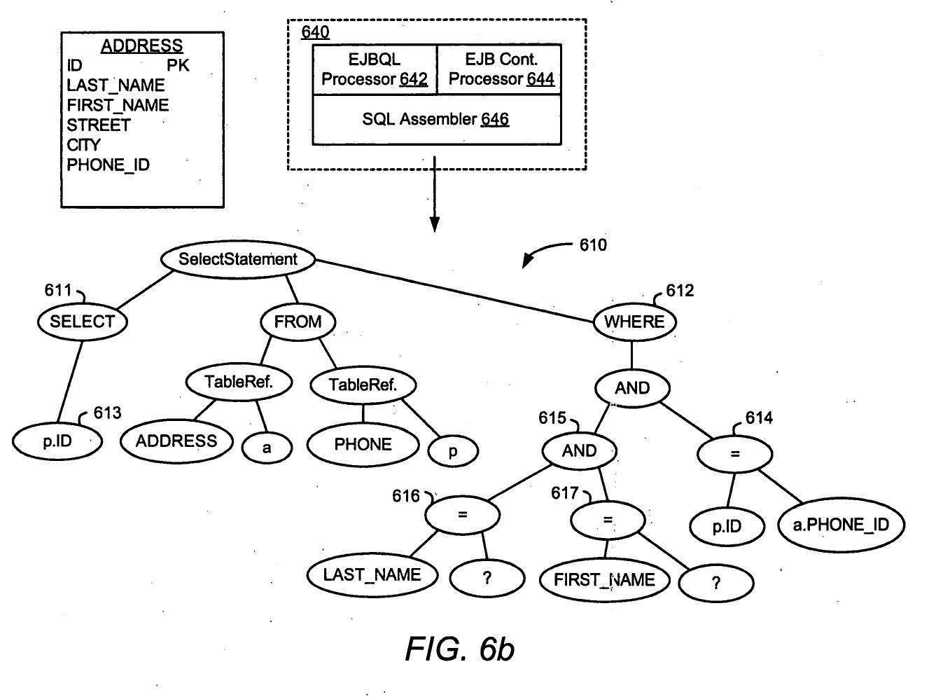

In an embodiment, the output of SQL mapper implementation 430 is described by SQL mapping result implementation 450. In one embodiment, the SQL statement(s) provided by SQL mapping result implementation 450 are organized as a tree structure in which each element of the SQL statement is represented by a node of the tree structure. Organizing the information in a tree structure enhances the processing of persistence requests by providing a more efficient, more complete, and reusable presentation of data related to a persistence request (e.g., data source, type of statement, conditional clauses, etc.). An example of an SQL statement organized as a tree structure is shown below with reference to FIG. 6.

In one embodiment, the SQL statement(s) provided by SQL mapping result implementation 450 are database-independent. The term “database-independent” refers to, for example, an SQL statement that is portable across a number of databases provided by a number of different vendors. In such an embodiment, SQL mapper implementation 430 may map a received persistence request to an SQL statement that is known to be database-independent. For example, in an embodiment, a set of SQL statements may be chosen that are a subset of standard SQL-92 statements, for example, a subset of statements that comply with the American National Standards Institute/International Organization or Standardization (ANSI/ISO) 9075: 1992 Information Technology—Database Languages—SQL standard (hereinafter, the SQL-92 Standard). The subset of standard SQL-92 statements may be selected, at least in part, based on whether they are database-independent. In one embodiment, the subset of standard SQL-92 statements is supplemented with additional SQL statements that are known to be database-independent.

In an embodiment, SQL mapping result implementation 450 implements mapping result interface 460 to provide the SQL mapping result to an EJB container (e.g., container 340, shown in FIG. 3). Mapping result interface 460 may provide an implementation of one or more methods that provide access to an SQL mapping result and/or manipulation of an SQL mapping result. For example, in an embodiment, mapping result interface 460 may provide a method to determine whether an SQL mapping result is database-independent.

In an embodiment, SQL mapping result implementation 450 may derive database-specific SQL statements for given database vendors from its internal database-independent SQL statement representation. For example, one or more methods may be provided that allow an end-user (or program) to specify a specific database (e.g., via a database product name and/or a database vendor identifier). In an embodiment, the one or more methods may be used by SQL mapping result implementation 450 to derive an SQL statement string representation of the SQL statement that is specific to the identified database.

FIG. 5 is a block diagram of selected aspects of SQL mapper implementation 500, implemented according to an embodiment of the invention. The illustrated embodiment includes EJB interpreting layer 510 and SQL assembly layer 520. In an alternative embodiment of the invention, SQL mapper implementation 500 may include more elements, fewer elements, and/or different elements than those depicted in FIG. 5.

In an embodiment, EJB interpreting layer 510 includes EJBQL processor 530 to interpret EJBQL persistence requests. In one embodiment, the received EJBQL persistence requests are organized as tree structures in which each element of the persistence request is represented by a node of the tree structure. In such an embodiment, EJBQL processor 530 traverses the tree structure representing the EJBQL persistence request and transforms the information it encounters into appropriate method calls to underlying SQL assembly layer 520. In an embodiment, SQL assembly layer 520 assembles an SQL statement in a step-wise fashion as it receives the method calls from EJBQL processor 530. In such an embodiment, once EJBQL processor 530 has completely traversed the tree structure representing the persistence request, SQL assembly layer 520 has completely assembled, for example, an SQL statement representing the original EJBQL persistence request.

In an embodiment, EJBQL processor 530 employs a number of classes to interpret the received persistence request. For example, the illustrated embodiment includes ConditionProcessor class 532, SimpleConditionProcessor class 534, ArithmeticExpressionProcessor class 536, and StringExpressionProcessor class 538. In an embodiment, ConditionProcessor class 532 interprets combined conditions of a WHERE clause within the received persistence request. Similarly, SimpleConditionProcessor class 534 may interpret elementary conditions (as well as simple arithmetic and Boolean conditions) of the WHERE clause. In an embodiment, ArithmeticExpressionProcessor class 536 may be used to interpret more complex arithmetic expressions. In an embodiment, StringExpressionProcessor class 538 may be used to interpret one or more of the string expressions in a persistence request. SQL mapper implementation is easy-to-extend because, for example, new classes may be added to one or more of its layers to extend the functionality of the layer.

In an embodiment, EJB interpreting layer 510 includes EJB container processor 540 to process persistence requests from an EJB container (e.g., EJB container 340, shown in FIG. 3). The EJB container persistence requests may be directed to loading, storing, and removing EJBs as well as manipulating and maintaining Container Managed Relations (CMRs) between EJBs. In an embodiment, EJB container processor 540 receives EJB container persistence requests and, for each type of persistence request, sends a sequence of commands to SQL assembly layer 520. In an embodiment, the sequence of commands sent by the EJB container processor 540 are similar to those sent by EJBQL processor 530. In an embodiment, the sequence of commands is extended to handle the persistence requests directed to CMRs that may be received from the container.

SQL assembly layer 520 assembles SQL statements based, at least in part, on the commands (e.g., method calls) that it receives from EJB interpreting layer 510. In an embodiment, SQL assembly layer 520 provides a tree representation of the assembled SQL statement. In an embodiment, SQL assembly layer 520 employs one or more classes to assemble an SQL statement. For example, WhereNodeManager class 522 may generate a subtree of logic predicates representing an SQL statement's WHERE clause. In an embodiment, ExpressionNodeManager class 524 compiles the expressions used within those predicates.

Certain versions of the Java Database Connectivity (JDBC) Application Program Interface (API) may not support Boolean expressions (e.g., versions earlier than JDBC ver. 3.0). BooleanNodeManager class 526 may provide mappings to alternative expressions when mapping to Boolean expressions is not supported by the JDBC API. For example, if a WHERE predicate's right operand expression is to inherit type mapping from its corresponding left operand expression, BooleanNodeManager class 526 may support the type mapping. In an embodiment, Boolean literal values may be appropriately transformed in accordance with a prevailing type mapping. In such an embodiment, LiteralValueMapper class 528 may provide the appropriate transformation. Some constructs of a persistence request may involve the use of subqueries within an SQL statement. In an embodiment, SubqueryBuilder class 529 generates subqueries, as needed, for the SQL statement.

FIG. 6 is a conceptual illustration of generating SQL statement 610, according to an embodiment of the invention. In an embodiment, an EJB may include a number of user-defined EJBQL persistence requests (e.g.) defined in the deployment descriptor of the EJB). Listing 1 shows an illustrative user-defined EJBQL persistence request corresponding to FIG. 6

### LISTING 1

SELECT a.phone FROM AddressBean AS a WHERE a.lastName=?1 AND a.firstName=?2

In an embodiment, an EJBQL parser (not shown) parses, for example, the persistence request shown in Listing 1 and generates a tree structure representation of the persistence request as shown by EJBQL tree structure 630. In an embodiment, each node of EJBQL tree structure 630 represents an element of the persistence request shown in Listing 1. For example, EJBQL node 632 may represent the EJBQL persistence request generally while from node 634 and where node 636 represent the FROM clause and WHERE clause of the EJBQL persistence request. In an embodiment, relationships between EJBs may be also be represented by EJBQL tree structure 630. For example, a.phone node 639 may represent a relationship between address bean 620 and another EJB (not shown).

In an embodiment, SQL mapper implementation 640 receives an EJBQL persistence request such as, for example, EJBQL tree structure 630. SQL mapper implementation 640 may include EJBQL processor 642, EJB container processor 644, and SQL assembler 646. Since EJBQL tree structure 630 represents a user-defined EJBQL statement, in an embodiment, it may be interpreted by EJBQL processor 642. In an embodiment, EJBQL processor 642 traverses EJBQL tree structure 630 (e.g., with the help of classes such as 532-538, shown in FIG. 5) and generates a command(s) (e.g., method call(s)) for each node of tree structure 630.

In an embodiment, SQL assembler 646 generates SQL tree structure 610 in a step-wise fashion as it receives the command sequence from EJBQL processor 642. For example, as EJBQL processor 642 traverses select node 638 and where node 636, SQL assembler 646 may generate select node 611 and p.ID node 613 (representing the primary key of the other EJB (not shown) to which the relation phone of EJB AddressBean 620 is pointing) as well as where node 612 and AND node 615 and an equal join condition node 614 to realize the relation phone of EJB AddressBean 620. In an embodiment, SQL assembler 646 generates node elements for SQL tree structure 610 that are database-independent (e.g., elements selected from a subset of SQL-92 that are database-independent). In an alternative embodiment, SQL assembler 646 may generate platform-independent and/or platform dependent SQL statements.

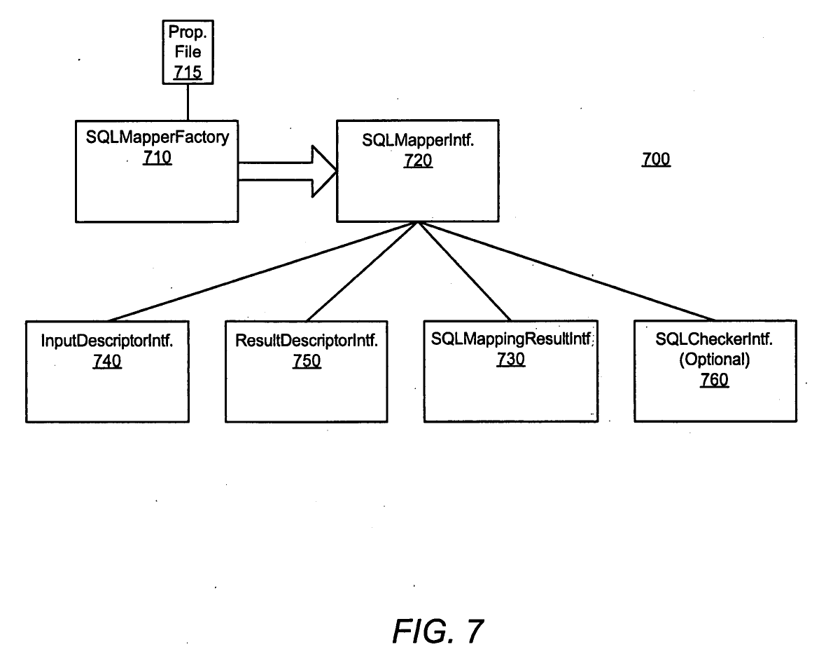

FIG. 7 is a block diagram of selected aspects of communication protocol (and API(s)) 700 providing communication between an EJB container and an SQL statement generator. In an embodiment, communication protocol 700 enables an EJB container (e.g., EJB container 340, shown in FIG. 3) to cooperate with any SQL statement generator (e.g., SQL mapper implementation 430, shown in FIG. 4). The illustrated embodiment of communication protocol 700 includes SQL mapper factory 710, SQL mapper interface 720, input descriptor interface 740, result descriptor interface 750, SQL mapping result interface 730, and SQL checker interface 760. In an alternative embodiment, communication protocol 700 may have more elements, fewer elements, and/or different elements.

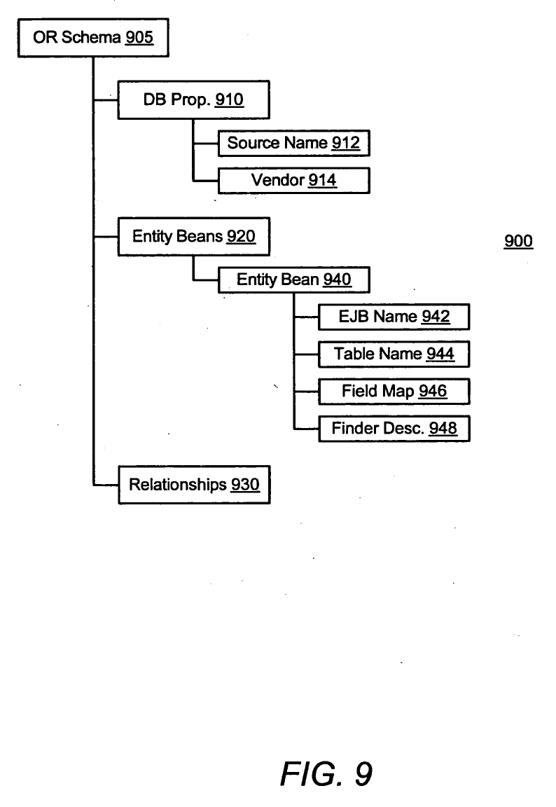

In an embodiment, SQL mapper factory 710 creates an SQL mapper implementation based, at least in part, on an OR mapping schema (e.g., OR mapping schema 900, shown in FIG. 9). In an embodiment, the actual implementation chosen for the SQL mapper instance is defined by a value in one or more properties files (e.g., properties file 715). For example, in an embodiment, the implementation is defined by a default property named “com.sap.ejb.ql.sqlmapper.SQLMapper.” In such an embodiment, the default properties may be set by default properties file “sqlm.properties” and local properties file “sqlmlocal.properties.” In an alternative embodiment, a wide variety of alternative property names and/or property files may be used. In an embodiment, an OR mapping schema is permanently bound to an SQL mapper instance. In such an embodiment, it may be preferable to create only one SQL mapper instance per OR mapping schema because SQL mapper implementations might use OR mapping caches for increased performance.

In an embodiment, SQL mapper factory 710 provides two methods for creating an instance of the SQL mapper. The first method takes as a parameter an OR mapping of an EJB abstract schema (e.g., OR mapping schema 900, shown in FIG. 9) and returns an SQL mapper instance. The second method takes as input parameters both the OR mapping schema and one or more runtime properties to define, at least in part, the runtime behavior of the SQL mapper instance. The SQL mapper instance may also provide a method to retrieve the name of a local properties file. In an alternative embodiment, SQL mapper factory 710 may have more methods, fewer methods, and/or different methods.

In an embodiment, SQL mapper interface 720 provides one or more methods to map an EJBQL persistence request to an SQL statement and/or to create various types of SQL statements used by an EJB container to manage persistency according to, for example, EJB Container Managed Persistence (CMP). In an embodiment, these mappings may be based, at least in part, on the SQL mapper's underlying OR mapping. Table 1 provides an illustrative set of methods provided by SQL mapper interface 720, according to an embodiment of the invention. In an alternative embodiment, SQL mapper interface 720 may provide more methods, fewer methods, and/or different methods than those shown in Table 1.

TABLE 1

| Method | Description |
|---|---|
| createEJBDelete( ) | Creates a DELETE statement to remove a |
| | certain EJB from a database with a given |
| | primary key. |
| createEJBIndirectSelect( ) | Creates a SELECT statement to load all |
| | columns of all database rows of a particular |
| | EJB that are in CMR with another particular |
| | EJB (identified by a given primary key). |
| createEJBInsert( ) | Creates an INSERT statement to store all |
| | database columns of a certain EJB. |
| createEJBSelect( ) | Creates a SELECT statement to load all |
| | database columns of a certain EJB. |
| createEJBUpdate ( ) | Creates an UPDATE statement to modify all |
| | non-primary-key database columns of a |
| | certain EJB with a given primary key. |
| createHelperTableDelete( ) | Creates a DELETE statement to remove a row |
| | from a helper table on the database |
| | representing an M:N CMR. |
| createHelperTableInsert( ) | Creates an INSERT statement to store a row |
| | into a helper table on the database representing |
| | an M:N CMR. |
| createHelperTableMultipleDelete( ) | Creates a DELETE statement to remove all |
| | entries that are related to a particular EJB with |
| | a given primary key from a helper table on the |
| | database representing an M:N CMR. |
| createHelperTableSelect( ) | Creates a SELECT statement to load all |
| | foreign key columns related to a particular |
| | EJB with a given primary key. |
| mapEjbQl( ) | Maps a given EJBQL persistence request to, if |
| | possible, a database-independent SQL |
| | representation. |
| setNativeMode( ) | Indicates that resulting SQL statements are to |
| | be used for native, for example, database- |
| | dependent SQL only. |
| setSelectAllBeanFields( ) | Ensures that EJBQL persistence requests with |
| | an identification variable as a select clause |
| | will be mapped to SQL statements that return |
| | the database representation of all of the |
| | respective EJB's fields. |
| setSelectPrimarykeyFields( ) | Ensures that EJBQL persistence requests with |
| | an identification variable as a select clause |
| | will be mapped to SQL statements that return |
| | only the primary key fields of the respective |
| | EJB's database representation. |

In an embodiment, SQL mapper interface 720 provides three different mapEjbQl( ) methods. The first mapEjbQl( ) method takes as a parameter an EJBQL persistence request and returns an SQLMappingResult (e.g., a representation of a corresponding SQL statement) for the EJBQL persistence request. The second mapEjbQl( ) method has an additional parameter of makeDistinct. The parameter makeDistinct may be used when the return type of the respective EJB finder/select method requires the generated SQL statement to be a SELECT DISTINCT statement (irrespective of whether the underlying EJBQL persistence request itself has been specified as DISTINCT). In an embodiment, the third mapEjbQl( ) method includes the two parameters discussed above and takes as an additional parameter haveForUpdate. In such an embodiment, a FOR UPDATE clause is added to the generated SQL representation if the haveForUpdate parameter is set to true.

In an embodiment, SQL mapping result interface 730 provides a description of the results of the mapping from an EJB persistence request to an SQL statement (or a representation of an SQL statement). In one embodiment, the EJB persistence request may be an EJBQL persistence request or an EJB container persistence request. In an embodiment, the SQL mapping result may be a database-independent representation of the resulting SQL statement. In such an embodiment, however, the SQL statement string based on the mapping result may be database-specific.

SQL mapping result interface 730 may provide one or more methods to interact with a mapping result. For example, in an embodiment, the method getStatementString( ) may be used to retrieve an SQL statement string as computed by the EJBQL to SQL mapping. In one embodiment, SQL mapping result interface 730 may include one or more methods to enable an end-user to determine what kind of statement string representation is returned by the getStatementString( ) method. For example, methods such as setNativeSQL(int) and/or setNativeSQL(String) may be used to set a database-specific SQL statement string representation. Similarly a method such as setOpenSQL( ) may be used to set a database-independent SQL statement string representation.

Table 2 provides a selected set of methods that may be provided by SQL mapping result interface 730. The listed methods are for illustrative purposes and it is to be understood that method names and descriptions may be changed without departing from the scope of an embodiment of the invention. Also, SQL mapping result interface 730, may provide more methods, fewer methods, and/or different methods than those listed in Table 2.

TABLE 2

| Method | Description |
|---|---|
| getInputDescriptors( ) | Retrieves an array having descriptions of input |
| | parameters of an SQL statement. |
| getResultDescriptors( ) | Retrieves an array of column descriptions for a |
| | result set to be returned by an SQL statement. |
| getSQLStatement( ) | Retrieves an SQL statement tree as computed |
| | by the EJBQL to SQL mapping. |
| getStatementString( ) | Retrieves the SQL |
| | statement string as computed |
| | by the EQBQL to SQL mapping. |
| hasOpenSQLVersion( ) | Indicates, for example, whether a database- |
| | independent SQL statement's string |
| | representation may be generated. |
| setNativeSQL( ) | Sets a native, for example, database-dependent |
| | SQL statement string representation. |
| setOpenSQL( ) | Sets, for example, a database-independent |
| | statement string representation. |

In an embodiment, input descriptor interface 740 provides a description of an input parameter for an SQL statement with respect to EJB terminology. For example, if an SQL statement is mapped from an EJBQL persistence request, then the SQL statement's input parameters may be described with regards to the input parameters of the EJB finder/select method on which the EJBQL persistence request is based. Similarly, if the SQL statement is based on an EJB load/store request, then the SQL statement's input parameters may be described in terms of the EJB container.

Table 3 provides a selected set of methods that may be provided by input descriptor interface 740. The listed methods are for illustrative purposes and it is to be understood that method names and descriptions may be changed without departing from the scope of an embodiment of the invention. Also, input descriptor interface 740, may provide more methods, fewer methods, and/or different methods than those listed in Table 3.

TABLE 3

| Method | Description |
|---|---|
| getEjbfieldName( ) | Retrieves the abstract field name referenced by |
| | the SQL input parameter. |
| getEjbName( ) | Retrieves the abstract bean type name of the |
| | respective finder/select method's input |
| | parameter or of the abstract bean involved in |
| | the EJB load/store request. |
| getInputParameter( ) | Retrieves the ordinal position of the EJB |
| | finder/select method's referred input parameter. |
| getJdbcType( ) | Retrieves the JDBC type of the SQL input |
| | parameter. |
| getPosition( ) | Retrieves the ordinal position of an SQL input |
| | parameter within an SQL statement. |
| isBean( ) | Indicates whether the referred finder/select |
| | method's input parameter is an abstract bean |
| | type. |

In an embodiment, result descriptor interface 750 provides, for example, a description of a result set column of an SQL statement mapped from an EJBQL persistence request (or, in some embodiments, an EJB container persistence request). In one embodiment, result descriptor interface 750 provides a method (e.g., an isObjectRepresentation( ) method) to determine whether a result set column is part of a bean object's representation (e.g., based on its primary key fields). In such an embodiment, the isObjectRepresentation( ) method may indicate to an EJB container whether to create a bean object or to simply return a CMP field. The information provided by this method may be useful if, for example, an abstract bean type's primary key consists of one primary key field only.

Table 4 provides a selected set of methods that may be provided by result descriptor interface 750. The listed methods are for illustrative purposes and it is to be understood that method names and descriptions may be changed without departing from the scope of an embodiment of the invention. Also, result descriptor interface 750, may provide more methods, fewer methods, and/or different methods than those listed in Table 4.

TABLE 4

| Method | Description |
|---|---|
| getEjbfieldName( ) | Retrieves the abstract bean field name |
| | referenced by the result set column. |
| getEjbName( ) | Retrieves the abstract bean type name to which |
| | the result set column is referring. |
| getJdbcType( ) | Retrieves the JDBC type of the result set |
| | column. |
| getPosition( ) | Retrieves the ordinal position of a column |
| | within the result set to which a result set |
| | descriptor is referring. |
| isBean( ) | Indicates whether a referenced column |
| | represents an abstract bean field. |
| isObjectRepresentation( ) | Indicates whether a column is part of a bean |
| | object's representation (e.g., based, at least |
| | partly, on whether the column is part of a bean |
| | object's primary key representation). |

In an embodiment, SQL checker interface 760 provides, one or more methods to check an SQL statement (or a representation of an SQL statement such as SQL statement tree 610, shown in FIG. 6b) against an “SQL grammar” used by an underlying SQL mapper implementation. The term “SQL grammar” refers to one or more syntactical and/or semantical rules that define a permissible SQL statement. The term “SQL checker” refers to logic that checks an SQL statement (or a representation of an SQL statement) against a defined SQL grammar. In an embodiment, SQL checker interface 760 may dynamically (e.g., during runtime) access the SQL checker to check an SQL statement.

In one embodiment, SQL checker interface 760 provides a method such as checkSQLStatement( ) to determine the permissibility of an SQL statement. The checkSQLStatement( ) method may take as a parameter an SQL statement (or a representation of an SQL statement) and throw an exception if the SQL statement does not comply with the SQL grammar of the underlying SQL mapper implementation. SQL checker interface 760 may also provide a setProperties( ) method to set one or more runtime properties of an SQL checker implementation. In one embodiment, an SQL checker implementation may use the runtime properties to create an appropriate CatalogReader. The term “CatalogReader” may refer to logic for interacting with metadata describing database tables that have been designed and deployed with, for example, a data dictionary.

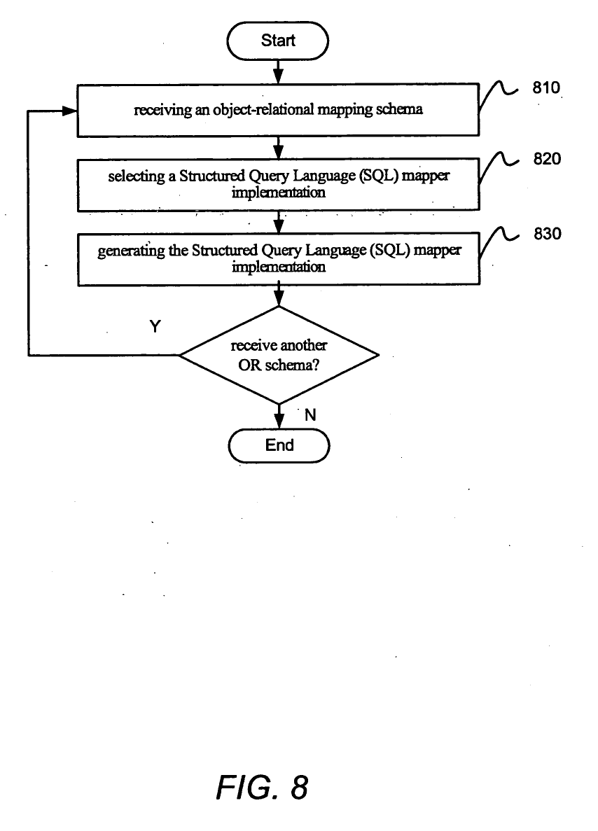

Turning now to FIGS. 8-10, the particular methods associated with embodiments of the invention are described in terms of computer software and hardware with reference to a flowchart. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement embodiments of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 8 is a flow diagram illustrating selected aspects of a communication protocol according to an embodiment of the invention. Referring to process block 810, a communication protocol (e.g., communication protocol 700, shown in FIG. 7) receives an object-relational (OR) mapping schema. The term “OR mapping schema” broadly refers to the mapping between an EJB (or the abstract schema describing, at least partly, the EJB) or a collection of EJBs (or the abstract schema describing, at least partly, the collection of EJBs) and an underlying database (or the schema describing the underlying database).

FIG. 9 is an illustration of selected elements of OR mapping schema 900 according to an embodiment of the invention. OR mapping schema 900 illustrates an example of a document type definition that describes how to specify information about database mappings of, for example, container-managed entity beans. The illustrated embodiment of OR mapping schema 900 includes root element 905, database properties element 910, entity beans element 920, and relationships element 930. In an alternative embodiment, OR mapping schema 900 may have more elements, fewer elements, and/or different elements.

Database properties element 910 may provide information about the database to which an EJB (or a collection of EJBs) is mapped. For example, source name element 912 may provide a data source name. Similarly, vendor element 914 may specify a database vendor (e.g., SAPDB).

In an embodiment, entity beans element 920 contains a list of, for example, container-managed entity EJBs to which the abstract schema applies. For each listed EJB, entity beans element 920 may contain entity bean properties and database mappings. For example, entity bean element 940 may represent a listed entity bean. In an embodiment, entity beans element 920 may contain a number of entity bean elements 940 and each one may represent a listed entity bean.

The illustrated embodiment of entity bean element 940 includes EJB name element 942, table name element 944, and field map element 946. In an embodiment, entity bean name element 942 includes the name of the entity as specified in its deployment descriptor (e.g., its ejb-jar.xml). Table name element 944 may include the name of a database table in which the entity bean's persistent data is stored. In one embodiment, each EJB from the abstract schema is stored in a separate table. Field map element 946 may describe the database mappings between CMP fields of the EJB and columns in the database. Relationships element 930 may contain information about relationships between listed EJBs and one or more other EJBs (including, for example, other listed EJBs).

Referring again to FIG. 8, an SQL mapper implementation is selected at process block 820. In an embodiment, the selection of the SQL mapper implementation is based, at least in part, on one or more values in one or more property files. For example, in an embodiment, the implementation is defined by a default property named “com.sap.ejb.ql.sqlmapper.SQLMapper.” In such an embodiment, the default properties may be set by default properties file “sqlm.properties” and local properties file “sqlmlocal.properties.” In an alternative embodiment, a wide variety of alternative property names and/or property files may be used.

Referring to process block 830, the SQL mapper implementation is generated based, at least in part, on the OR mapping schema. In an embodiment, a caller passes an OR mapping schema to an SQL mapper factory (e.g., SQL mapper factory 710, shown in FIG. 7). The SQL mapper factory may generate an SQL mapper implementation (e.g., SQL mapper implementation 430, shown in FIG. 4). In an embodiment, the SQL mapper implementation provides methods to map EJB persistence requests to SQL statements.

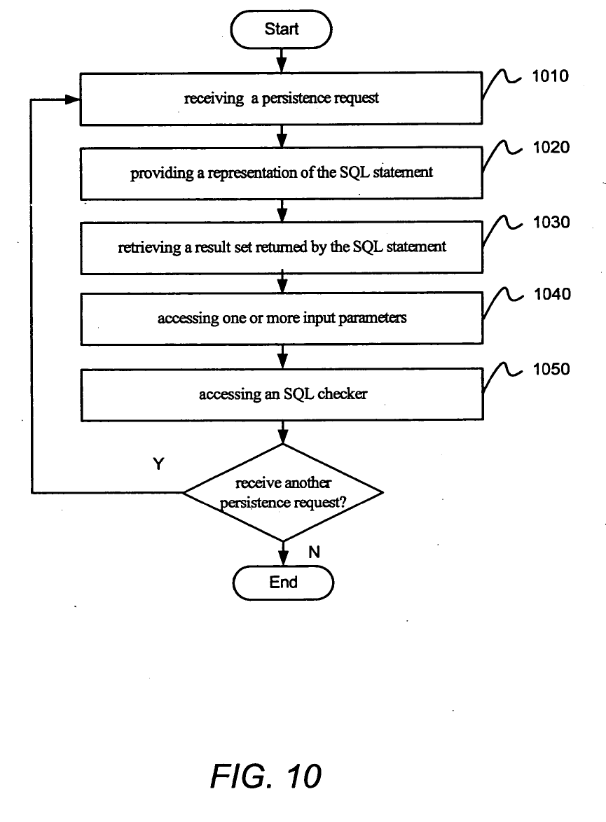

FIG. 10 is a flow diagram illustrating selected aspects of a communication process according to an embodiment of the invention. Referring to process block 1010, an SQL mapper interface (e.g., SQL mapper interface 720, shown in FIG. 7) receives an EJB persistence request. In an embodiment, the EJB persistence request may be an EJBQL persistence request and/or an EJB container persistence request. The SQL mapper interface may provide one or more methods to map an EJB persistence request to an SQL statement.

Referring to process block 1020, an SQL mapping result interface provides a representation of the SQL statement. In an embodiment, the SQL mapping result interface may provide a database-independent representation of the SQL statement. The SQL mapping result interface may provide one or more methods to specify one or more types of SQL statements strings. For example, the SQL mapping result interface may provide methods to generate a database-independent and/or a database-specific SQL statement string.

Referring to process block 1040, one or more input parameters of the SQL statement may be accessed from an input descriptor interface of the SQL mapper implementation. The term “accessing input parameters” may refer to using one or more methods to, for example, access: an abstract bean field name referenced by an SQL input parameter; an abstract bean type name of a finder/select method's input parameter; an ordinal position of an EJB finder/select method's referenced input parameter; the JDBC type of the SQL input parameter; the ordinal position of an SQL input parameter within an SQL statement; and the like.

Referring to process block 1030, a description of a result set column returned by the SQL statement may be retrieved from a result descriptor interface of the SQL mapper implementation. In an embodiment, the result descriptor interface provides one or more methods to indicate whether the result set column is part of a bean object's primary key representation. If the result set column is part of the bean object's primary key representation, then an EJB container may create a bean object. Otherwise, the EJB container may return a CMP field.

Referring to process block 1040, one or more input parameters of the SQL statement may be accessed from an input descriptor interface of the SQL mapper implementation. The term “accessing input parameters” may refer to using one or more methods to, for example, access: an abstract bean field name referenced by an SQL input parameter; an abstract bean type name of a finder/select method's input parameter; an ordinal position of an EJB finder/select method's referenced input parameter; the JDBC type of the SQL input parameter; the ordinal position of an SQL input parameter within an SQL statement; and the like.

Referring to process block 1050, an SQL checker interface of the SQL mapper implementation is accessed to determine whether an SQL statement complies with a specified SQL grammar. In an embodiment the SQL checker interface provides access to an SQL checker defining a permissible SQL grammar. The SQL statement (or a representation of the SQL statement) may be checked against the SQL grammar to determine whether it complies with one or more syntactical and/or semantical rules.

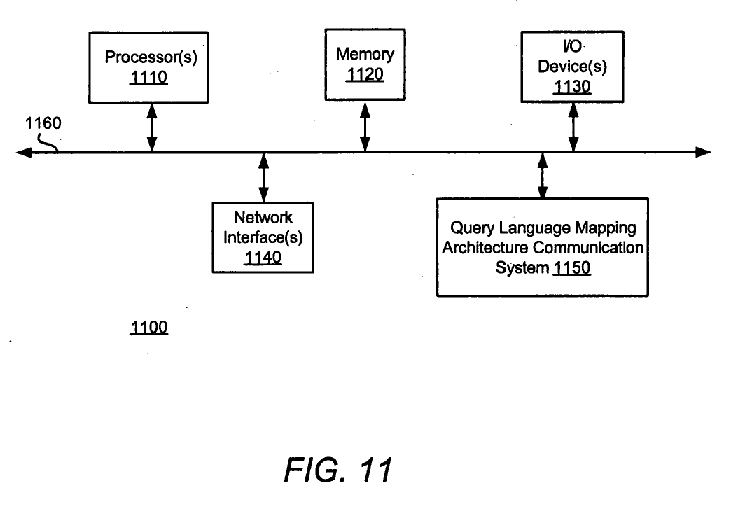

FIG. 11 is a block diagram of node 1100 implemented according to an embodiment of the invention. Node 1100 may include: processor(s) 1110, memory 1120, one or more Input/Output devices 1130, network interface(s) 1140, and query language mapping architecture communication system 1150. The illustrated elements may be connected together through system interconnection 1160. Processor(s) 1110 may include a microprocessor, microcontroller, field programmable gate array (FPGA), application specific integrated circuit (ASIC), central processing unit (CPU), programmable logic device (PLD), and similar devices that access instructions from system storage (e.g., memory 1120), decode them, and execute those instructions by performing arithmetic and logical operations.

Query language mapping architecture communication system 1150 may facilitate communication between an EJB container and an SQL statement generator. Query language mapping architecture communication system 1150 may be executable content, control logic (e.g., ASIC, PLD, FPGA, etc.), firmware, or some combination thereof, in an embodiment of the invention. In embodiments of the invention in which query language mapping architecture communication system 1150 is executable content, it may be stored in memory 1120 and executed by processor(s) 1110.

Memory 1120 may encompass a wide variety of memory devices including read-only memory (ROM), erasable programmable read-only memory (EPROM), electrically erasable programmable read-only memory (EEPROM), random access memory (RAM), non-volatile random access memory (NVRAM), cache memory, flash memory, and other memory devices. Memory 1120 may also include one or more hard disks, floppy disks, ZIP disks, compact disks (e.g., CD-ROM), digital versatile/video disks (DVD), magnetic random access memory (MRAM) devices, and other system-readable media that store instructions and/or data. Memory 1120 may store program modules such as routines, programs, objects, images, data structures, program data, and other program modules that perform particular tasks or implement particular abstract data types that facilitate system use.

One or more I/O devices 1130 may include a hard disk drive interface, a magnetic disk drive interface, an optical drive interface, a parallel port, serial controller or super I/O controller, serial port, universal serial bus (USB) port, a display device interface (e.g., video adapter), a network interface card (NIC), a sound card, modem, and the like. System interconnection 1160 permits communication between the various elements of node 1100. System interconnection 1160 may include a wide variety of signal lines including one or more of a memory bus, peripheral bus, local bus, host bus, bridge, optical, electrical, acoustical, and other propagated signal lines.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A method comprising:
receiving an object-relational mapping schema to define a mapping between one or more persistence fields of one or more Enterprise Java Beans (EJBs) and one or more tables of a database;
selecting a Structured Query Language (SQL) mapper implementation to generate based, at least in part, on a value specified in a properties file; and
generating the Structured Query Language (SQL) mapper implementation based, at least in part, on the object-relational mapping schema.

2. The method of claim 1, further comprising:
receiving an Enterprise Java Bean (EJB) persistence request at an SQL mapper interface of the SQL mapper implementation, the SQL mapper interface providing one or more methods to map an EJB persistence request to an SQL statement.

3. The method of claim 2, wherein receiving the EJB persistence request comprises at least one of:
receiving an EJB Query Language (EJBQL) persistence request; and
receiving an EJB container persistence request.

4. The method of claim 2, further comprising:
providing a representation of the SQL statement at an SQL mapping result interface.

5. The method of claim 4, wherein providing the representation of the SQL statement at the SQL mapping result interface comprises:
providing a database-independent representation of the SQL statement at the SQL mapping result interface.

6. The method of claim 4, wherein providing the representation of the SQL statement at the SQL mapping result interface comprises:
providing a database-dependent representation of the SQL statement at the SQL mapping result interface.

7. The method of claim 4, wherein providing the representation of the SQL statement at the SQL mapping result interface comprises:
providing an SQL statement string based, at least in part, on a mapping between the EJB persistence request and the SQL statement.

8. The method of claim 7, wherein providing the SQL statement string comprises:
providing a database-independent SQL, statement string based, at least in part, on a mapping between the EJB persistence request and the SQL statement.

9. The method of claim 7, wherein providing the SQL statement string comprises:
providing a database-dependent SQL statement string based, at least in part, on a mapping between the EJB persistence request and the SQL statement.

10. The method of claim 2, further comprising:
accessing one or more input parameters of the SQL statement from an input descriptor interface of the SQL mapper implementation.

11. The method of claim 10, wherein accessing one or more input parameters of the SQL statement comprises:
accessing parameter position information indicating a position of an input parameter within the EJB persistence request.

12. The method of claim 2, further comprising:
retrieving a description of a result set returned by the SQL statement from a result descriptor interface of the SQL mapper implementation.

13. The method of claim 12, wherein retrieving the description of the result set returned by the SQL statement comprises at least one of:
retrieving an indication to generate an EJB object; and
retrieving an indication to return a Container Managed Persistence (CMP) field.

14. The method of claim 2, further comprising:
accessing an SQL checker from an SQL checker interface to determine whether the SQL statement complies with a specified SQL grammar.

15. The method of claim 14, wherein accessing the SQL checker from an SQL checker interface to determine whether the SQL statement complies with the specified SQL grammar comprises:
accessing the SQL checker to determine whether the SQL statement is database-independent.

16. The method of claim 1, wherein receiving the object-relational mapping schema further comprises:
receiving an object-relational mapping schema having relationship information to define a relationship between the EJB and another EJB.

17. A system comprising:
a Structured Query Language (SQL) mapper factory to receive an object-relational mapping schema and to generate an SQL mapper instance based, at least in part, on the object-relational mapping schema;
a Structured Query Language (SQL) mapper interface to provide one or more methods to map an Enterprise Java Bean (EJB) persistence request to an SQL statement; and
an SQL mapping result interface to provide a representation of the SQL statement.

18. The system of claim 17, further comprising:
a result descriptor interface to retrieve a description of a result set returned by the SQL statement.

19. The system of claim 17, further comprising:
an input descriptor interface to access one or more input parameters of the SQL statement.

20. The system of claim 17, further comprising:
an SQL checker to provide a specified SQL grammar; and
an SQL checker interface to access the SQL checker to determine whether the SQL statement complies with the specified SQL grammar.

21. The system of claim 20, wherein the specified SQL grammar comprises:
one or more syntactical and semantical rules defining the SQL grammar.

22. A system comprising:
means for receiving an object-relational mapping schema to define a mapping between one or more persistence fields of one or more Enterprise Java Beans (EJBs) and one or more tables of a database;
means for selecting a Structured Query Language (SQL) mapper implementation to generate based, at least in part, on a value specified in a properties file; and
means for generating the Structured Query Language (SQL) mapper implementation based, at least in part, on the object-relational mapping schema.

23. The system of claim 22, further comprising:
means for receiving an Enterprise Java Bean (EJB) persistence request at an SQL mapper interface of the SQL mapper implementation, the SQL mapper interface providing one or more methods to map an EJB persistence request to an SQL statement.

24. The system of claim 23, further comprising:
means for providing a representation of the SQL statement at an SQL mapping result interface.

25. The system of claim 23, further comprising:
means for retrieving a description of a result set returned by the SQL statement from a result descriptor interface of the SQL mapper implementation.

26. The system of claim 23, further comprising:
means for accessing one or more input parameters of the SQL statement from an input descriptor interface of the SQL mapper implementation.

27. An article of manufacture comprising:
an electronically accessible medium providing instructions that, when executed by an apparatus, cause the apparatus to:
receive an object-relational mapping schema to define a mapping between one or more persistence fields of one or more Enterprise Java Beans (EJBs) and one or more tables of a database;
select a Structured Query Language (SQL) mapper implementation to generate based, at least in part, on a value specified in a properties file; and
generate the Structured Query Language (SQL) mapper implementation based, at least in part, on the object-relational mapping schema.

28. The article of manufacture of claim 27, wherein the electronically accessible medium provides further instructions that, when executed by the apparatus, cause the apparatus to:
receive an Enterprise Java Bean (EJB) persistence request at an SQL mapper interface of the SQL mapper implementation, the SQL mapper interface providing one or more methods to map an EJB persistence request to an SQL statement.

29. The article of manufacture of claim 28, wherein the electronically accessible medium provides further instructions that, when executed by the apparatus, cause the apparatus to:
provide a representation of the SQL statement at an SQL mapping result interface.

30. The article of manufacture of claim 28, wherein the electronically accessible medium provides further instructions that, when executed by the apparatus, cause the apparatus to:
retrieve a description of a result set returned by the SQL statement from a result descriptor interface of the SQL mapper implementation.

31. The article of manufacture of claim 28, wherein the electronically accessible medium provides further instructions that, when executed by the apparatus, cause the apparatus to:
access one or more input parameters of the SQL statement from an input descriptor interface of the SQL mapper implementation.

32. The article of manufacture of claim 28, wherein the electronically accessible medium provides further instructions that, when executed by the apparatus, cause the apparatus to:
access an SQL checker from an SQL checker interface to determine whether the SQL statement complies with a specified SQL grammar.
